(19) United States
(12) Patent Application Publication
(10) Pub. No.: US 2025/0220242 A1
(43) Pub. Date: Jul. 3, 2025

(54) BITSTREAM SYNTAX FOR ADAPTIVE LINEAR WAVELET TRANSFORM

(71) Applicant: Tencent America LLC, Palo Alto, CA (US)

(72) Inventors: Jun TIAN, Belle Mead, NJ (US); Xiaozhong XU, State College, PA (US); Shan LIU, San Jose, CA (US)

(73) Assignee: Tencent America LLC, Palo Alto, CA (US)

(21) Appl. No.: 19/007,936

(22) Filed: Jan. 2, 2025

Related U.S. Application Data
(60) Provisional application No. 63/617,014, filed on Jan. 2, 2024.

(51) Int. Cl. H04N 19/63; H04N 19/117; H04N 19/167; H04N 19/172; H04N 19/196; H04N 19/61; H04N 19/70

(52) U.S. Cl. CPC H04N 19/63; H04N 19/117; H04N 19/167; H04N 19/172; H04N 19/196; H04N 19/61; H04N 19/70

(57) ABSTRACT

An aspect of the disclosure provides a method of mesh decoding. For example, a bitstream that includes coded information of a mesh frame is received. A syntax element is parsed from the bitstream, the syntax element indicates whether an adaptive linear wavelet transform is used, the adaptive linear wavelet transform applies different weight values to different neighboring vertices of a vertex in a wavelet transform of attribute values associated with vertices of the mesh frame. When the syntax element indicates a use of the adaptive linear wavelet transform, at least a first vertex in the vertices of the mesh frame is reconstructed according to the adaptive linear wavelet transform.

### INCORPORATION BY REFERENCE

The present application claims the benefit of priority to U.S. Provisional Application No. 63/617,014, “Bitstream Syntax for Adaptive Linear Wavelet Transform” filed on Jan. 2, 2024, which is incorporated by reference herein in its entirety.

### TECHNICAL FIELD

The present disclosure describes aspects generally related to mesh coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Various technologies are developed to capture and represent the world, such as objects in the world, environments in the world, and the like in 3-dimensional (3D) space. 3D representations of the world can enable more immersive forms of interaction and communication. For example, technology developments in 3D media processing, such as advances in three dimensional (3D) capture, 3D modeling, and 3D rendering, and the like have promoted the ubiquitous presence of 3D media contents across several platforms and devices. In an example, a baby's first step can be captured in one continent, media technology can allow grandparents to view (and maybe interact) and enjoy an immersive experience with the baby in another continent. According to an aspect of the disclosure, in order to improve immersive experience, 3D models are becoming ever more sophisticated, and the creation and consumption of 3D models occupy a significant amount of data resources, such as data storage, data transmission resources. In some examples, 3D meshes can be used as 3D representations of the world.

### SUMMARY

Aspects of the disclosure include bitstreams, methods, and apparatuses for mesh processing. In some examples, an apparatus for mesh processing includes processing circuitry.

An aspect of the disclosure provides a method of mesh decoding. For example, a bitstream that includes coded information of a mesh frame is received. A syntax element is parsed from the bitstream, the syntax element indicates whether an adaptive linear wavelet transform is used, the adaptive linear wavelet transform applies different weight values to different neighboring vertices of a vertex in a wavelet transform of attribute values associated with vertices of the mesh frame. When the syntax element indicates a use of the adaptive linear wavelet transform, at least a first vertex in the vertices of the mesh frame is reconstructed according to the adaptive linear wavelet transform.

Another aspect of the disclosure provides a method of mesh encoding. For example, to encode a mesh frame using an adaptive linear wavelet transform in a wavelet transform of attribute values associated with vertices in the mesh frame is determined. The adaptive linear wavelet transform applies different weight values to different neighboring vertices of a vertex in the wavelet transform. The mesh frame is encoded according to the adaptive linear wavelet transform to generate coded information of the mesh frame. A coded bitstream is formed, the coded bitstream includes the coded information of the mesh frame and a syntax element indicative of a use of the adaptive linear wavelet transform in the wavelet transform.

Another aspect of the disclosure provide a method of processing mesh data, the method includes processing a bitstream of the mesh data according to a format rule. The bitstream includes coded information of a plurality of vertices in a mesh frame. The format rule specifies that: a syntax element is parsed from the bitstream, the syntax element indicating whether an adaptive linear wavelet transform is used, the adaptive linear wavelet transform applying different weight values to different neighboring vertices of a vertex in a wavelet transform of attribute values associated with vertices of the mesh frame; and when the syntax element indicates a use of the adaptive linear wavelet transform, at least a first vertex in the vertices of the mesh frame is reconstructed according to the adaptive linear wavelet transform.

Aspects of the disclosure also provide an apparatus for mesh encoding. The apparatus for mesh encoding including processing circuitry configured to implement any of the described methods for mesh encoding.

Aspects of the disclosure also provide an apparatus for mesh decoding. The apparatus for mesh decoding including processing circuitry configured to implement any of the described methods for mesh decoding.

Aspects of the disclosure also provide a non-transitory computer-readable medium storing instructions which, when executed by a computer, cause the computer to perform any of the described methods for mesh decoding, encoding, and mesh data processing.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIG. 4 is a schematic illustration of an example of an encoding process for mesh processing according to an aspect of the disclosure.

FIG. 5 shows an example of a decoding process for mesh processing according to an aspect of the disclosure

FIG. 6 shows a diagram of a subdivision scheme in some examples.

FIG. 7 shows a diagram of an iteration step in the linear lifting transform of waveform transform in some examples.

FIG. 8 shows a pseudo code example for an application of adaptive linear wavelet transform in some examples.

FIG. 9 shows a pseudo code example for an application of adaptive linear wavelet transform in some examples.

FIG. 10 shows a flow chart outlining a mesh decoding process according to some aspects of the disclosure.

FIG. 11 shows a flow chart outlining a mesh encoding process according to some aspects of the disclosure.

FIG. 12 is a schematic illustration of a computer system in accordance with an aspect of the disclosure.

### DETAILED DESCRIPTION

Aspects of the disclosure provide techniques in the field of mesh processing.

A mesh (also referred to as mesh model) includes several polygons (also referred to as faces) that describe the surface of a volumetric object. Each polygon can be defined by vertices in three dimensional (3D) space and the information of how the vertices are connected, referred to as connectivity information. In some examples, the mesh also includes vertex attributes, such as colors, normals, displacements, and the like, that are associated with the mesh vertices. Further, in some examples, the mesh can include attributes associated with the surface of the mesh by exploiting mapping information that parameterizes the mesh with two dimensional (2D) attribute maps. Such mapping is usually described by a set of parametric coordinates, referred to as UV coordinates or texture coordinates, associated with the mesh vertices. 2D attribute maps are used to store high resolution attribute information, such as texture, normals, displacements, and the like. The 2D attribute maps can be used for various purposes such as texture mapping, shading and mesh reconstruction and the like.

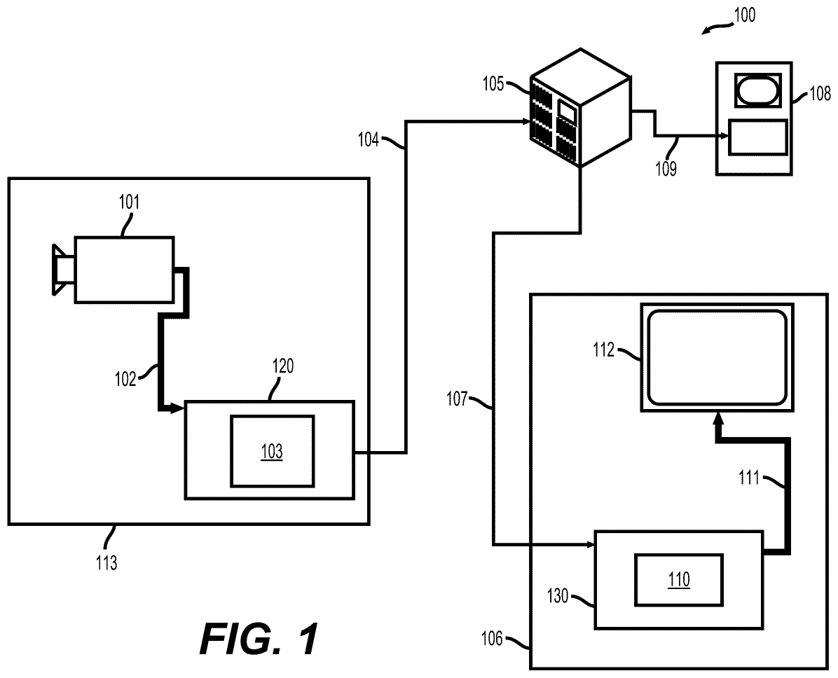

FIG. 1 shows a block diagram of a streaming system (100) in some examples.

The streaming system (100) is an example of an application for the disclosed subject matter, a mesh encoder and a mesh decoder in a streaming environment. The disclosed subject matter can be equally applicable to other mesh enabled applications, including, for example, conferencing, 3D TV, streaming services, storing of compressed 3D data on digital media including CD, DVD, memory stick and the like, and so on.

The streaming system (100) includes a capture subsystem (113), that can include a 3D source (101), for example light detection and ranging (LIDAR) systems, 3D cameras, 3D scanners, a graphics generation component and the like for creating a stream of 3D data (102) that are uncompressed. In an example, the stream of 3D data (102) includes samples that are taken by a 3D camera system. The stream of 3D data (102), depicted as a bold line to emphasize a high data volume when compared to encoded 3D data (104) (or encoded bitstreams), can be processed by an electronic device (120) that includes a 3D encoder (103) coupled to the 3D source (101). The 3D encoder (103) can include hardware, software, or a combination thereof to enable or implement aspects of the disclosed subject matter as described in more detail below. The encoded 3D data (104) (or encoded bitstream), depicted as a thin line to emphasize the lower data volume when compared to the stream of 3D data (102), can be stored on a streaming server (105) for future use. One or more streaming client subsystems, such as client subsystems (106) and (108) in FIG. 1 can access the streaming server (105) to retrieve copies (107) and (109) of the encoded 3D data (104). A client subsystem (106) can include a 3D decoder (110), for example, in an electronic device (130). The 3D decoder (110) decodes the incoming copy (107) of the encoded 3D data and creates an outgoing stream of 3D representation (111) that can be rendered on a display (112) (e.g., display screen) or other rendering device (not depicted). In some streaming systems, the encoded 3D data (104), (107), and (109) (e.g., video bitstreams) can be encoded according to certain 3D coding/compression standards, such as mesh coding/compression standards and the like.

It is noted that the electronic devices (120) and (130) can include other components (not shown). For example, the electronic device (120) can include a 3D decoder (not shown) and the electronic device (130) can include a 3D encoder (not shown) as well.

It is also noted that, in some examples, the 3D encoders and/or the 3D decoders can use 2D encoding/decoding techniques. For example, the 3D encoder and/or the 3D decoders can include video encoders or video decoders.

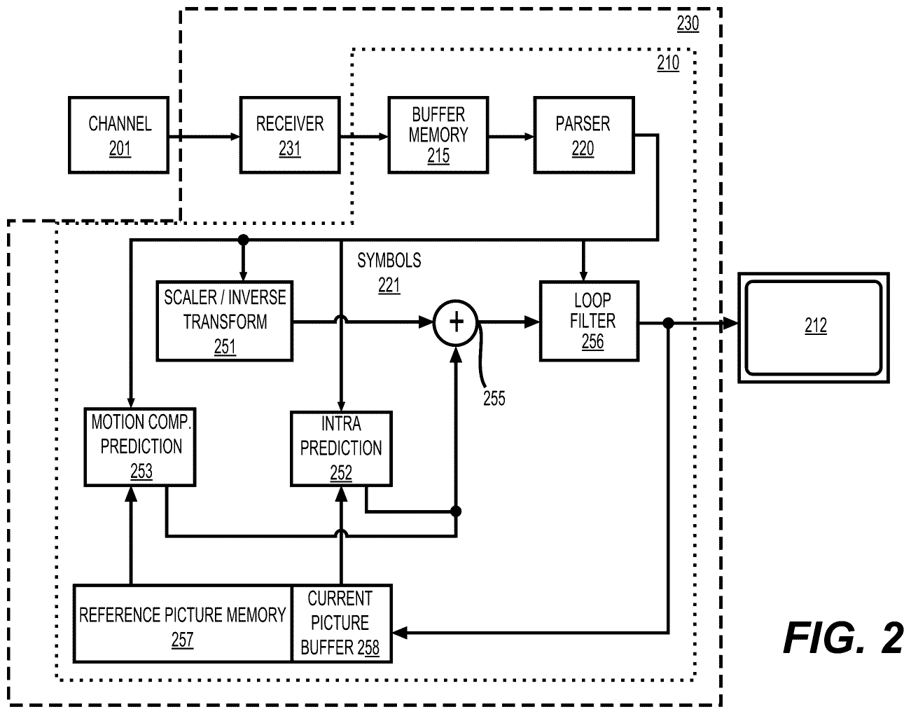

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the 3D decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

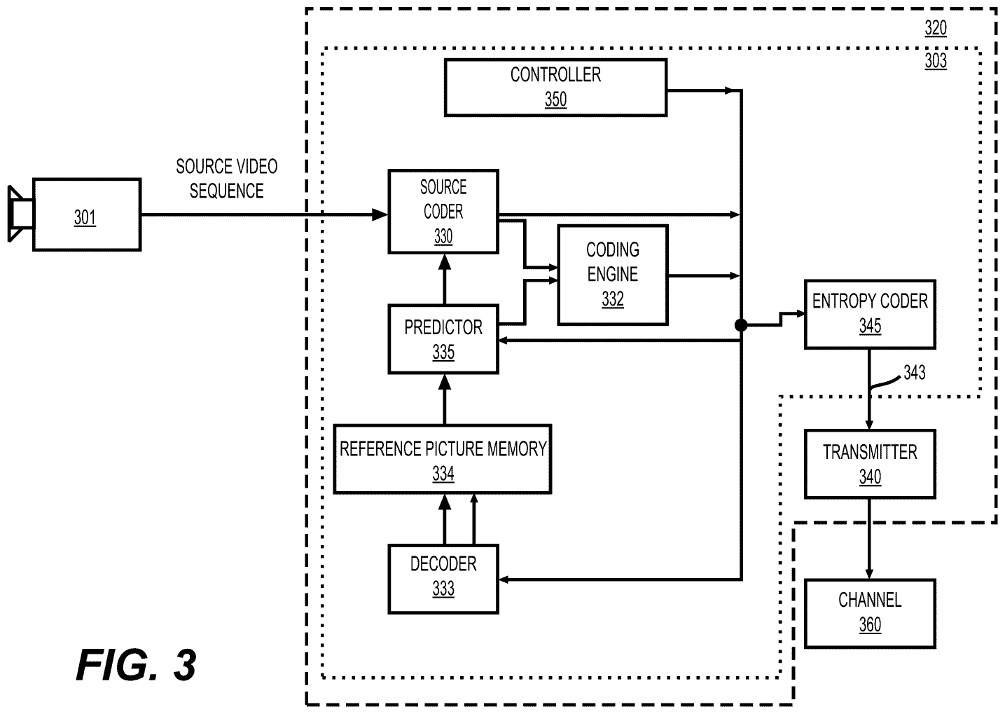

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the 3D encoder (103) in the FIG. 1 example.

The video encoder (303) may receive video samples from a video source (301) (that is not part of the electronic device (320) in the FIG. 3 example) that may obtain video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determinee a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the encoders (103) and (303), and the decoders (110) and (210) can be implemented using any suitable technique. In an aspect, the encoders (103) and (303) and the decoders (110) and (210) can be implemented using one or more integrated circuits. In another aspect, the encoders (103) and (303), and the decoders (110) and (210) can be implemented using one or more processors that execute software instructions.

In some examples, the 3D data includes mesh models, and the 3D encoder (103) can include a mesh encoder, and the 3D decoder (110) can include a mesh decoder.

According to an aspect of the disclosure, a dynamic mesh is a mesh where at least one of the components (geometry information, connectivity information, mapping information, vertex attributes and attribute maps) varies with time. A dynamic mesh can be described by a sequence of meshes (also referred to as mesh frames). In some examples, mesh frames in a dynamic mesh can be representations of a surface of an object at different time, and each mesh frame is a representation of the surface of the object at a specific time (also referred to as a time instance). The dynamic mesh may require a large amount of data since the dynamic mesh may include a significant amount of information changing over time. Compression technologies of meshes can allow efficient storage and transmission of media contents in the mesh representation.

A dynamic mesh sequence may require a large amount of data since the dynamic mesh may include a significant amount of information changing over time. Therefore, efficient compression technologies may be used to store and transmit such contents.

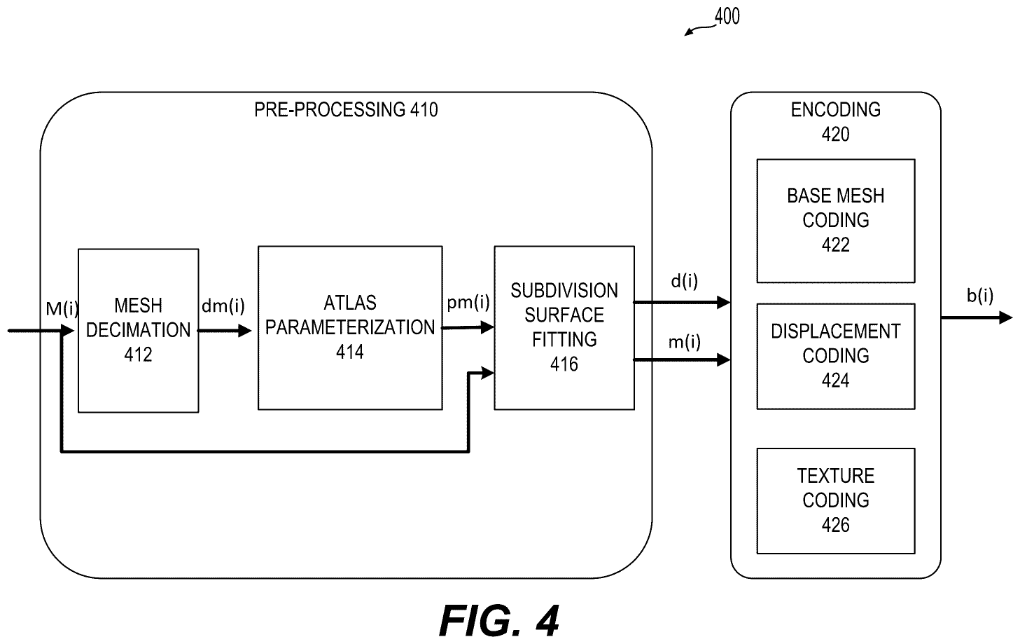

FIG. 4 shows an example of an encoding process (400) for mesh processing according to an aspect of the disclosure. As shown in FIG. 4, the encoding process (400) includes a pre-processing step (410) and an encoding step (420). The pre-processing step (410) is configured to generate a base mesh m(i) of a current frame and a displacement field d(i) of the current frame that includes displacement vectors according to an input mesh M(i) of the current frame. The input mesh M(i) is a first representation of the current frame, and the base mesh m(i) with the displacement field d(i) can be a second representation of the current frame. The encoding step (420) is configured to encode the base mesh m(i), the displacement field d(i), and texture information of the base mesh m(i). The displacement field d(i) of the current frame includes displacement vectors. An index i is used to refer to the current frame. In an aspect, a mode decision method may be performed in the encoding process (400) to determine whether inter coding (also referred to as inter frame prediction or an inter mode), intra coding (also referred to as intra frame prediction or an intra mode), or the like is applied to the current frame. For example, the mode decision method may compare a cost of an intra mode and a cost of an inter mode and decide a coding mode of the base mesh m(i) of the current frame based on which one of the costs is smaller. In some examples, a skip mode is used to code the base mesh m(i). In an example, the skip mode is a special mode of the inter mode. For example, the base mesh m(i) may be intra coded, or inter coded, or coded with the SKIP mode.

Still referring to FIG. 4, the pre-processing step (410) may include a mesh decimation process (412), a parameterization process, such as an atlas parameterization process (414), and a subdivision surface fitting process (416). In an example, the mesh decimation process (412) is configured to down-sample vertices of the input mesh M(i) to generate a decimated mesh dm(i) that may include a plurality of decimated (or down-sampled) vertices. For example, a number of the plurality of decimated vertices is less than a number of the vertices of the input mesh M(i). The parameterization process, such as the atlas parameterization process (414) is configured to map the decimated mesh dm(i) onto a planar domain, such as onto a UV atlas (or a UV map), to generate a re-parameterized mesh pm(i). In an example, the atlas parameterization may be performed based on a video processing tool, such as a UV Atlas tool. The subdivision surface fitting process (416) is configured to take the re-parameterized mesh pm(i) and the input mesh M(i) as inputs and produce a based mesh m(i) together with the displacement field d(i), the displacement field d(i) includes the displacement vectors or a set of displacements. In an example of the subdivision surface fitting process (416), pm(i) is subdivided by using a subdivision scheme such as an iterative interpolation to obtain a subdivided mesh. The iterative interpolation includes inserting at each iteration a new point in a middle of each edge of the re-parameterized mesh pm(i). Any suitable subdivision scheme may be applied to subdivide pm(i). The displacement field d(i) is computed by determining a nearest point on a surface of the input mesh M(i) for each vertex of the subdivided mesh.

An advantage of the subdivided mesh may include that the subdivided mesh has a subdivision structure that allows efficient compression, while offering a faithful approximation of the input mesh. An increase in compression efficiency may be obtained due to the following properties. The decimated mesh dm(i) may have a low number of vertices and may be encoded and transmitted using a lower number of bits than the input mesh M(i) or the subdivided mesh. Referring to FIG. 4, the base mesh m(i) may be generated from the decimated mesh dm(i). In an example, the base mesh m(i) is the decimated mesh dm(i). As the subdivided mesh may be generated based on the subdivision method, the subdivided mesh may be automatically generated by the decoder when the base mesh or the decimated mesh is decoded (e.g., there is no need to use any information other than the subdivision scheme and a subdivision iteration count). At the decoder side, the displacement field d(i) may be generated by decoding the displacement vectors associated with the vertices of the subdivided mesh. Besides allowing for spatial/quality scalability, the subdivision structure enables efficient transforms such as wavelet decomposition, which can offer high compression performance.

In the FIG. 4 example, the encoding step (420) includes a base mesh coding (422), a displacement coding (424), a texture coding (426), and the like. The base mesh coding (422) is configured to encode geometric information of the base mesh m(i) associated with the current frame. In an intra encoding, the base mesh m(i) may be first quantized (e.g., using uniform quantization) and then encoded, for example, by the coding mode determined using the mode decision method. The coding mode may be the inter mode, the intra mode, the skip mode, or the like. The encoder used to intra code the base mesh m(i) may be referred to as a static mesh encoder. In the inter encoding, a reference base mesh (e.g., a reconstructed quantized reference base mesh m′(j)) associated with a reference frame indicated by an index j may be used to predict the base mesh m(i) associated with the current frame indicated by the index i. The displacement coding (424) is configured to encode the displacement field d(i) that is generated in the pre-processing step (410). The displacement field d(i) may include a set of displacement vectors (or displacements) associated with the subdivided mesh vertices. The texture coding (426) is configured to encode attribute information of the base mesh m(i). The attribute information may include texture, normal, color, and/or the like. The attribute information may be encoded based on a suitable codec, such as High-Efficiency Video Coding (HEVC) or Versatile Video Coding (VVC).

In an aspect, referring to FIG. 4, a mesh encoding process such as the encoding process (420) starts with a pre-processing (e.g., the pre-processing step (410)). The pre-processing may convert the input mesh (e.g., the input dynamic mesh) M(i) into the base mesh m(i) together with the displacement field d(i) including a set of displacements (or a set of displacement vectors). The encoding step (420) may compress outputs (e.g., m(i), d(i), and the like) from the pre-processing and generate a compressed bitstream b(i). The compressed bitstream b(i) may include a compressed base mesh bitstream, a compressed displacement field bitstream, a compressed attribute bitstream, and/or the like.

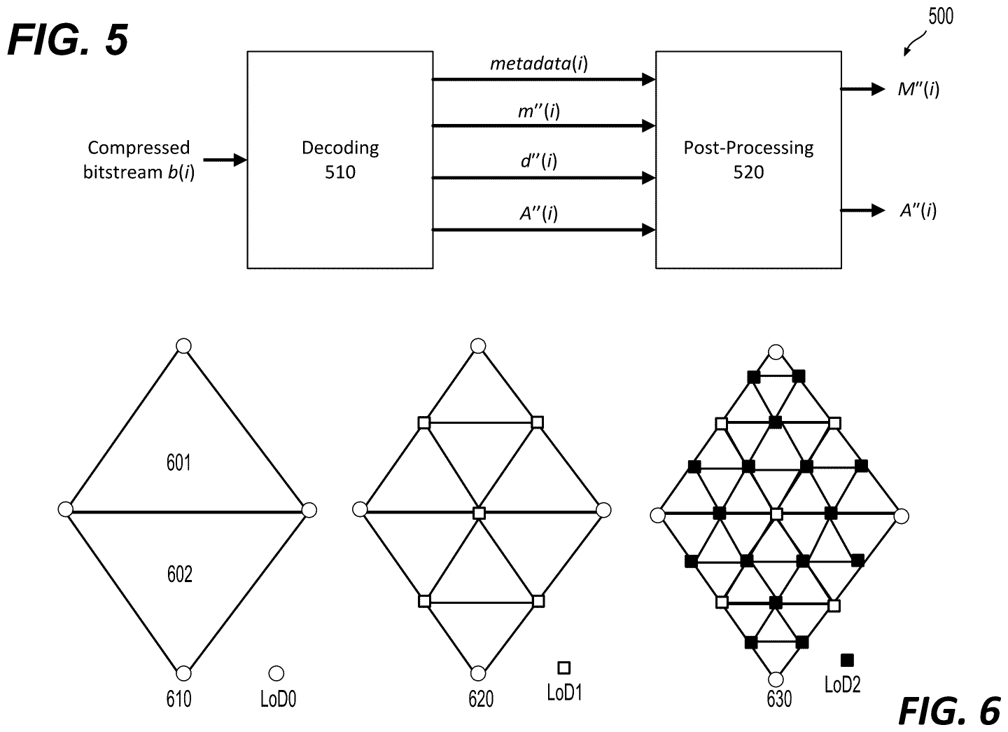

FIG. 5 shows an example of a decoding process (500) for mesh processing according to an aspect of the disclosure. The decoding process (500) may include a decoding step (510) and a post-processing step (520). A compressed bitstream b(i) may be fed to the decoding step (510). In an example, such as for a lossless transmission, the compressed bitstream b(i) is the output b(i) from the encoding process (400). The decoding step (510) may extract various sub-bitstreams such as the compressed base mesh sub-stream, the compressed displacement field sub-stream, the compressed attribute sub-stream, and/or the like. The decoding step (510) may decompress the sub-bitstreams to generate the following components: patch metadata indicated by metadata(i), a decoded base mesh m″(i), a decoded displacement field (including displacements) d′(i), a decoded attribute map A″(i), and/or the like.

In an aspect, the base mesh sub-stream may be fed to a mesh decoder to generate a reconstructed quantized base mesh m′(i). The decoded base mesh (or reconstructed base mesh) m″(i) may be obtained by applying an inverse quantization to m′(i). The displacement field sub-stream including packed and quantized wavelet coefficients that are encoded may be decoded by a video and/or image decoder. Image unpacking and inverse quantization may be applied to the packed quantized wavelet coefficients that are reconstructed to obtain the unpacked and unquantized transformed coefficients (e.g., wavelet coefficients). An inverse wavelet transform may be applied to the unpacked and unquantized wavelet coefficients to generate the decoded displacement field (or reconstructed displacement) d″(i).

The decoded components (e.g., including metadata(i), m″(i), d″(i), A″(i), and/or the like) may be fed to a post-processing step (520). A mesh (also referred to as a decoded/reconstructed mesh) M″(i) may be generated by the post-processing step (520) based on m″(i) and d″(i). In an example, the mesh M″(i) (also referred to as a reconstructed deformed mesh DM(i)) may be obtained by subdividing m″(i) using a subdivision scheme and applying the reconstructed displacements d″(i) to vertices of a subdivided mesh. In an example, the DM (i) may include the displaced curve. In an example, when the encoding process (400), the decoding process (500), and the transmission are lossless, the mesh M″(i) may be identical to the input mesh M(i). When one of the encoding process (400), the decoding process (500), and the transmission is lossy, M″(i) is different from M(i). In various examples, the difference, if any, between M″(i) and M(i) may be relatively small. In an example, an attribute map A″(i) is also generated by the post-processing step (520).

FIG. 6 shows a diagram of a subdivision scheme in some examples. The subdivision scheme shown in FIG. 6 is referred to as a mid-point subdivision scheme. Using the mid-point subdivision scheme, a mesh can be subdivided by adding a mid-point for each edge to divide each edge into two shorter edges. The mid-point subdivision scheme may, at each subdivision iteration, subdivide each triangle into 4 sub-triangles as shown in FIG. 6.

In the FIG. 6 example, an initial mesh (610) (without subdivision, also referred to as subdivision level 0) can be the re-parameterized mesh pm(i), the initial mesh (610) includes initial vertices (shown as blank circles) that form two triangles (601) and (602) as shown in FIG. 6. At a first subdivision iteration, a first plurality of vertices (show as blank squares in FIG. 6) are generated from the initial mesh (610) according to the mid-point subdivision scheme, and the initial mesh (610) is converted to a first level subdivision mesh (620). For example, the triangle (601) is subdivided into 4 smaller triangles, and the triangle (602) is also subdivided into 4 smaller triangles. At a second subdivision iteration, a second plurality of vertices (shown as dark squares in FIG. 6) are generated from the first level subdivision mesh (620) according to the mid-point subdivision scheme, and the first level subdivision mesh (620) is converted to a second level subdivision mesh (630). Each triangle in the first level subdivision mesh (620) is subdivided into 4 triangles at the second subdivision iteration.

In some examples, the displacement field d(i) is computed by determining a nearest point on a surface of the original (or input) mesh M(i) for each vertex of the subdivided mesh. For example, a set of displacement vectors can be determined for the first plurality of vertices and the second plurality of vertices. In an example, a displacement vector for a vertex can be a vector difference of the nearest point on the surface of the input mesh M(i) to the vertex. A first set of displacement vectors for the first plurality of vertices can add level of details on the initial mesh (610), a second set of displacement vectors for the second plurality of vertices can add level of details on the first level subdivision mesh (620).

In the FIG. 6 example, information of the initial vertices in the initial mesh (610) is of level of detail 0 (LoD0). After first subdivision iteration, information (e.g., the displacement vectors) associated with the first plurality of vertices (show as blank squares in FIG. 6) is of level of detail 1 (LoD1). After the second subdivision iteration, information (e.g., the displacement vectors) associated with the second plurality of vertices (shown as dark squares in FIG. 6) is of level of detail 2 (LoD2).

In some examples, an encoder can encode a set of displacement vectors associated with the subdivided mesh vertices, referred to as the displacement field d(i). In some examples, at the encoder side, a reconstructed quantized base mesh m′(i) is reconstructed based on the encoded information of the bash mesh m(i), and the displacement field d(i) is updated according to the reconstructed quantized base mesh m′(i) to generate an updated displacement field d′(i). The updated displacement field d′(i) is then converted using a transform technique, such as a wavelet transform, to generate a set of wavelet coefficients. The wavelet coefficients can then be quantized. The quantized wavelet coefficients are compressed using an arithmetic coding, or any other suitable coding techniques, such as coding techniques used in image/video encoder or other suitable encoders.

In some examples, the wavelet transform, such as in MPEG V-DMC 2.0, is based on a linear lifting transform. The linear lifting transform applies lifting iteration steps on signals at different LoDs to generate detail coefficients of the different LoDs. A lifting iteration step applied on a current LoD includes a prediction process and an update process. The prediction process can generate detail coefficients (also referred to as detail signal) of the current LoD, and the update process can update signals of a lower LoD (also referred to as coarse signal). Then, a lifting iteration step (including a prediction process and an update process) can be performed on the updated signals of the lower LoD.

In some examples, the prediction process of detail coefficients associated with vertices of current LoD can be performed according to Eq. (1):

$$Detail ( v ) ← Signal ( v ) - \frac{1}{2} ( Signal ( {v}_{1} ) + Signal ( {v}_{2} ) ) \qquad Eq . ( 1 )$$

where v is a vertex of current LoD positioned in a middle of an edge (v₁, v₂) that is defined by two vertices v₁ and v₂ of a lower LoD. Signal(v), Signal(v₁), and Signal(v₂) denote values of signals (e.g., displacement signals, geometry/vertex attribute signals and the like) associated with the vertices v, v₁, and v₂, respectively, Detail(v) denotes the detail coefficient associated with the vertex v in the detail signal. According to Eq. (1), an average of Signal(v₁) and Signal(v₂) is calculated as a predictor of Signal(v), and a detail coefficient associated with v is calculated as a difference of Signal(v) to the predictor of Signal(v).

In some examples, the update process of signals associated with vertices of lower LoD can be performed according to Eq. (2):

$$Coarse ( v ) ← Signal ( v ) + \frac{1}{8} {\sum }_{w ∈ {v}^{*}} Detail ( w ) \qquad Eq . ( 2 )$$

where v is a vertex of lower LoD, v* is a set of neighboring vertices of the vertex v. It is noted that in an example, the neighboring vertices of the vertex v are of higher LoD (e.g., the current LoD) than the vertex v. The update process uses the detail coefficients of the neighboring vertices to update the coarse signal (denoted by Coarse (v)) which represents the running average.

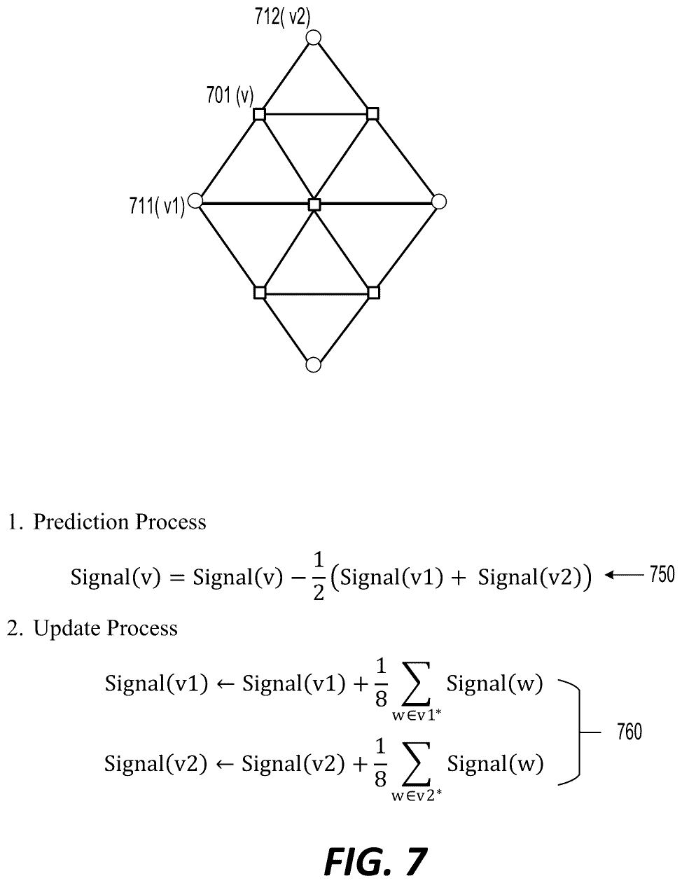

It is noted that, in some implementation examples, same storage places can be used for the variables Signal, Detail and Coarse, such as an example shown in FIG. 7.

FIG. 7 shows a diagram of an iteration step in the linear lifting transform of waveform transform in some examples. The iteration step includes a prediction process and an update process. In the FIG. 7 example, blank squares represent vertices of a current LoD, and the blank circles represent vertices of a lower LoD. The detail coefficients of the vertices of the current LoD are calculated by the prediction process in the iteration step. For example, for a vertex (701) of the current LoD, the detail coefficient is calculated as shown by (750) in the prediction process of the iteration step. For the vertices of the lower LoD, signals associated with the vertices of the lower LoD are updated by the update process in the iteration step. For example, for vertices (711) and (712) of the lower LoD, the signals are updated as shown by (760) in the update process of the iteration step. Then, the updated signals of the lower LoD can be further processed by another iteration step.

Further, according to some aspects of the disclosure, an adaptive wavelet transform, such as an adaptive linear wavelet transform can be used for wavelet transform. The adaptive linear wavelet transform also uses a lifting scheme with a prediction process and an update process. In an aspect, a weight in the update process is based on distances between a vertex and neighboring vertices of the vertex in order to update the running average adaptively.

In some examples, the prediction process of the lifting scheme is referred to as applying a prediction filter, and the various weights used in the prediction process are referred to as weighting coefficients of the prediction filter. Further, the update process of the lifting scheme is referred to as applying an update filter, and the various weights used in the update process are referred to as weighting coefficients of the update filter.

In an aspect, such as at an encoder side, the prediction process of detail coefficients associated with vertices of current LoD in the adaptive linear wavelet transform (also referred to as forward adaptive linear lifting transform) can be performed according to Eq. (3):

$$Detail ( v ) ← Signal ( v ) - \frac{1}{2} ( Signal ( {v}_{1} ) + Signal ( {v}_{2} ) ) \qquad Eq . ( 3 )$$

where v is a vertex of current LoD positioned in a middle of an edge (v₁, v₂) that is defined by two vertices v₁ and v₂ of a lower LoD. Signal(v), Signal(v₁), and Signal(v₂) denote values of signals (e.g., displacements and the like) associated with the vertices v, v₁, and v₂, respectively, Detail(v) denotes the detail coefficient associated with the vertex v in the detail signal. According to Eq. (3), an average of Signal(v₁) and Signal(v₂) is calculated as a predictor of Signal(v), and a detail coefficient associated with the vertex v is calculated as a difference of Signal(v) to the predictor of Signal(v).

In an aspect, such as at the encoder side, the update process of signals associated with vertices of lower LoD in the adaptive linear wavelet transform can be performed according to Eq. (4):

$$Coarse ( v ) ← Signal ( v ) + c \times {\sum }_{w ∈ {v}^{*}} \frac{Detail ( w )}{dist ( v , w )} \qquad Eq . ( 4 )$$

where v is a vertex of lower LoD, v* is a set of neighboring vertices of the vertex v, dist(v,w) is a distance function between vertices v and w, and c is a scalar constant. It is noted that in an example, the neighboring vertices of the vertex v are of higher LoD than the vertex v. The distance function provides a distance between the vertex v and each vertex w in the set of neighboring vertices v*. The update process uses the detail coefficients of the neighboring vertices to update the coarse signal (denoted by Coarse (v) which represents the running average of the samples) in an adaptive manner based on distances from the neighboring vertices (of the current LoD) to the vertex v of the lower LoD.

As shown in Eq. (4), a ratio for each of the plurality of neighboring vertices (e.g., v*) is determined. The ratio is equal to a value of the respective detail coefficient of neighboring vertex (e.g., w) over a distance between the vertex v and the respective neighboring vertex. It is noted that in an example, the neighboring vertices of the vertex v are of higher LoD than the vertex v. In some examples, a sum of the ratios of the plurality of neighboring vertices is determined; and further a product of(i) a constant (e.g., c) and (ii) the sum of the ratios of the plurality of neighboring vertices is determined.

According to an aspect of the disclosure, an inverse adaptive transform, such as an inverse adaptive linear wavelet transform, can be used at the decoder side. The inverse adaptive linear wavelet transform include iteration steps to iteratively process received signals. For example, the iteration steps can determine the displacements of vertices by increasing the LoD. In some examples, an iteration step includes an (updo) update process followed by (undo) prediction process, where the (undo) update process comes before the (undo) prediction process.

In an aspect, such as at the decoder side, for an iteration step of a current LoD, a detail signal (e.g., denoted by Detail(v)) for vertices of the current LoD, and coarse signals for vertices of the lower LoD (e.g., denoted by Coarse (v)) are received. For a vertex v of the current LoD that is positioned in a middle of two vertices (v₁ and v₂) of the lower LoD, the (undo) update process in the inverse adaptive transform is performed according to Eq. (5) and Eq. (6):

$$Signal ( {v}_{1} ) ← Coarse ( {v}_{1} ) - c \times {\sum }_{w ∈ {v}_{1}^{*}} \frac{Detail ( w )}{dist ( {v}_{1} , w )} \qquad Eq . ( 5 )$$

$$Signal ( {v}_{2} ) ← Coarse ( {v}_{2} ) - c \times {\sum }_{w ∈ {v}_{2}^{*}} \frac{Detail ( w )}{dist ( {v}_{2} , w )} \qquad Eq . ( 6 )$$

where v₁* is a set of neighboring vertices of the vertex v₁, v₂* is a set of neighboring vertices of the vertex v₂, dist(v₁,w) is a distance function between vertices v₁ and w, dist(v₂,w) is a distance function between vertices v₂ and w, and c is a scalar constant.

In an aspect, such as the decoder side, the (undo) prediction process of the iteration step for the vertex v of the current LoD in the inverse adaptive wavelet transform can be performed according to Eq. (7):

$$Signal ( v ) ← Detail ( v ) + \frac{1}{2} ( Signal ( {v}_{2} ) + Signal ( {v}_{2} ) ) \qquad Eq . ( 7 )$$

where v is a vertex in a middle of an edge (v₁, v₂). Signal(v), Signal(v₁), and Signal(v₂) are values of the vertices v, v₁, and v₂, such as displacement signals, values of geometry/vertex attribute signals (or geometry/vertex attribute information) at the vertices v, v₁, and v₂, respectively. Further, the Signal(v) can be the coarse signal for higher LoD, and another iteration step can be performed to process information associated with vertices of higher LoD.

In an aspect, the distance function shown in Eq. (4), Eq. (5), and Eq. (6) is an l¹ distance (e.g., one-dimensional distance). In an aspect, the distance function is an l² distance (e.g., two-dimensional distance). In an aspect, the distance function is an l⁰ distance, which is equal to 2 (e.g., always equal to 2) for two vertices. In an aspect, the distance function is an IP distance (e.g., p-dimensional distance), where p>=0.

According to an aspect of the disclosure, the update process in the (forward) adaptive linear lifting transform in Eq. (4) can be suitably modified, for example, can be modified according to Eq. (8):

$$Coarse ( v ) ← Signal ( v ) + \frac{c}{\vert {v}^{*} \vert} \times {\sum }_{w ∈ {v}^{*}} \frac{Detail ( w )}{dist ( v , w )} \qquad Eq . ( 8 )$$

where |v*| is a cardinal number of v*, such as a total number of vertices in the set v*, a valence of the vertex v.

In some examples, the adaptive linear wavelet transform is applied to selected (or preselected) mesh frame(s) of a mesh sequence.

In some examples, the adaptive linear wavelet transform is applied to selected (or preselected) region(s) of a mesh frame.

In some examples, the plurality of vertices is included in a base layer of the mesh frame. In an example, a base layer of the mesh frame is also referred to as a level of detail 0 video, which contains low frequency coefficients. In an example, the base layer is a fundamental layer that stores core geometric information of the mesh. It may include vertices, edges, and faces of the mesh.

In some examples, the plurality of vertices is included in an enhancement layer of the mesh frame. In an example, the enhancement layer of the mesh frame includes additional information or functionality with respect to the base layer. For example, the enhancement layer may include texture coordinates, normals, and material properties (e.g., roughness, reflectivity, and emissivity).

In some examples, the adaptive linear wavelet transform is applied to selected (or preselected) frequency band(s) of a mesh frame.

Some aspects of the present disclosure provide techniques of using a bitstream syntax for adaptive linear wavelet transform in mesh coding. For example, an encoder can includes a syntax element in a bitstream that includes coded information of a mesh frame. The syntax element indicates whether an adaptive linear wavelet transform is used, the adaptive linear wavelet transform applies different weight values to different neighboring vertices of a vertex in a wavelet transform of attribute values associated with vertices of the mesh frame. At the decoder side, the decoder can reconstruct, when the syntax element indicates a use of the adaptive linear wavelet transform, at least a first vertex in the vertices of the mesh frame according to the adaptive linear wavelet transform.

According to an aspect of the disclosure, a one-bit flag can be used to signal whether or not the adaptive linear wavelet transform (also referred to as valence-based adaptive linear wavelet transform in some examples) is applied.

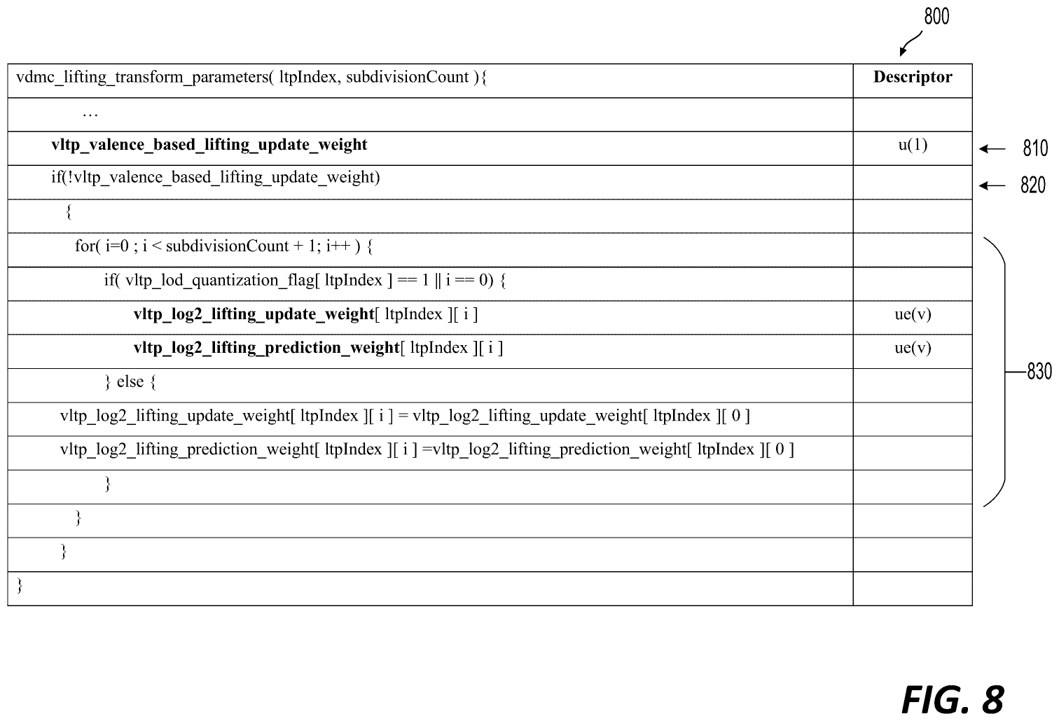

FIG. 8 shows a pseudo code example (800) for an application of adaptive linear wavelet transform in some examples.

In the FIG. 8 example, a syntax element vltp_valence_based_lifting_update_weight can be a one-bit flag that is used to signal whether or not an adaptive linear wavelet transform is applied. For example, the syntax element vltp_valence_based_lifting_update_weight of value 1 indicates the adaptive linear wavelet transform (also referred to as valence-based adaptive lifting update weight technique in an example) is applied; and the syntax element vltp_valence_based_lifting_update_weight of value 0 indicates that the adaptive linear wavelet transform is not applied, and a non-adaptive lifting update weight is applied.

Also in the pseudo code example (800), the syntax element vltp_log2_lifting_update_weight[ltpIndex][i] denotes the weighting coefficients used for the update filter (e.g., used in the update process) of the wavelet transform of the i^{th} level of details. ltpIndex is the index of the lifting transform parameter set.

Also in the pseudo code example (800), the syntax element vltp_log2_lifting_prediction_weight[ltpIndex][i] denotes the weighting coefficients used for the prediction filter (e.g., used in the prediction process) of the wavelet transform of the i^{th} level of details. ltpIndex is the index of the lifting transform parameter set.

In the FIG. 8 examples, a syntax element (e.g., a one-bit flag) vltp_valence_based_lifting_update_weight is signaled in a bitstream. The bitstream is formed by an encoder, and at a decoder, the decoder can extract the syntax element (e.g., a one-bit flag) vltp_valence_based_lifting_update_weight from the bitstream, such as shown by (810) in the pseudo code example (800).

In the FIG. 8 example, when the syntax element vltp_valence_based_lifting_update_weight is of value 0 (shown by (820) in FIG. 8), the syntax elements vltp_log2_lifting_update_weight[ltpIndex][i] and vltp_log2_lifting_prediction_weight[ltpIndex][i] can be set according to signals in the bitstream, such as shown by (830). When the syntax element vltp_valence_based_lifting_update_weight is of value 1 (not shown in FIG. 8), the weighting coefficients can be calculated according to the techniques associated with at least one of Eq. (4) to Eq. (8).

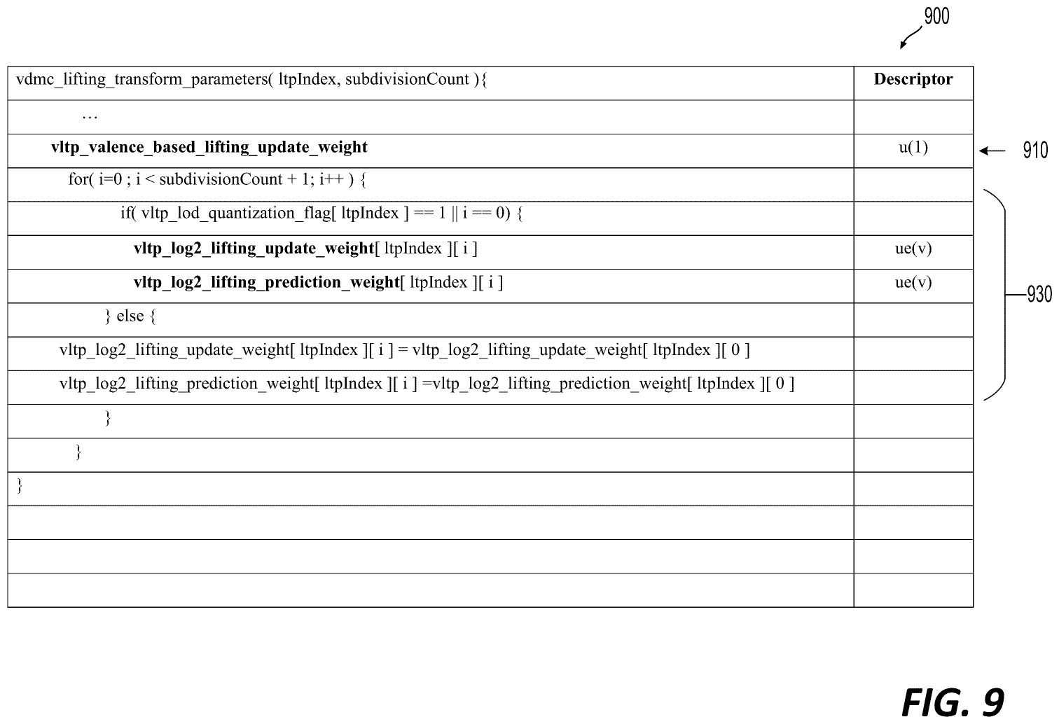

FIG. 9 shows a pseudo code example (900) for an application of adaptive linear wavelet transform in some examples.

In the FIG. 9 example, a syntax element vltp_valence_based_lifting_update_weight can be a one-bit flag that is used to signal whether or not an adaptive linear wavelet transform is applied. For example, the syntax element vltp_valence_based_lifting_update_weight of value 1 indicates the adaptive linear wavelet transform (also referred to as valence-based adaptive lifting update weight technique in an example) is applied; and the syntax element vltp_valence_based_lifting_update_weight of value 0 indicates that the adaptive linear wavelet transform is not applied, and a non-adaptive lifting update weight is applied.

Also in the pseudo code example (900), the syntax element vltp_log2_lifting_update_weight[ltpIndex][i] denotes the weighting coefficients used for the update filter (e.g., used in the update process) of the wavelet transform of the i^{th} level of details. ltpIndex is the index of the lifting transform parameter set.

Also in the pseudo code example (900), the syntax element vltp_log2_lifting_prediction_weight[ltpIndex][i] denotes the weighting coefficients used for the prediction filter (e.g., used in the prediction process) of the wavelet transform of the i^{th} level of details. ltpIndex is the index of the lifting transform parameter set.

In the FIG. 9 examples, a syntax element (e.g., a one-bit flag) vltp_valence_based_lifting_update_weight is signaled in a bitstream. The bitstream is formed by an encoder, and at a decoder, the decoder can extract the syntax element (e.g., a one-bit flag) vltp_valence_based_lifting_update_weight from the bitstream, such as shown by (910) in the pseudo code example (900).

In the FIG. 9 example, no matter the value of the syntax element vltp_valence_based_lifting_update_weight, the syntax elements vltp_log2_lifting_update_weight[ltpIndex][i] and vltp_log2_lifting_prediction_weight[ltpIndex][i] can be set according to signals in the bitstream, such as shown by (930). Further, when the syntax element vltp_valence_based_lifting_update_weight is of value 1 (not shown in FIG. 9), the weighting coefficients can be updated according to the techniques associated with at least one of Eq. (4) to Eq. (8); when the syntax element vltp_valence_based_lifting_update_weight is of value 0 (not shown in FIG. 9), the weighting coefficients are not updated according to the techniques associated with at least one of Eq. (4) to Eq. (8), and can be used as is in the (undo) update process and the (undo) prediction process.

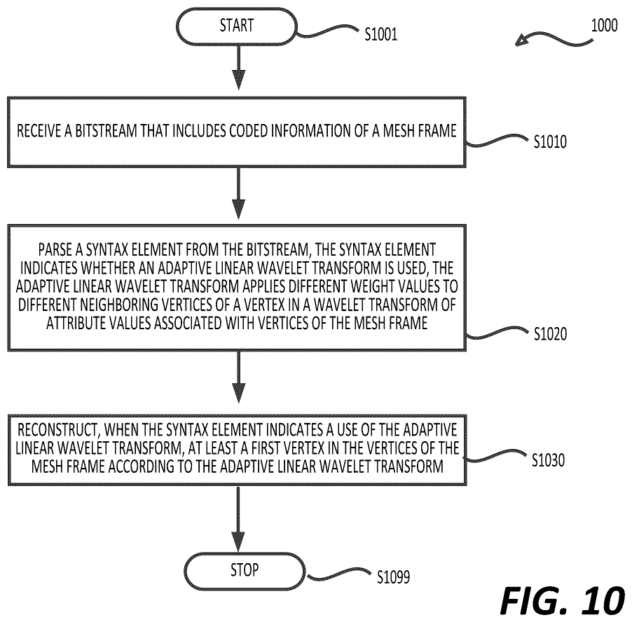

FIG. 10 shows a flow chart outlining a process (1000) according to an aspect of the disclosure. The process (1000) can be used in a video decoder. In various aspects, the process (1000) is executed by processing circuitry, such as the processing circuitry that performs functions of the video decoder (110), the processing circuitry that performs functions of the video decoder (210), and the like. In some aspects, the process (1000) is implemented in software instructions, thus when the processing circuitry executes the software instructions, the processing circuitry performs the process (1000). The process starts at (S1001) and proceeds to (S1010).

At (S1010), a bitstream that includes coded information of a mesh frame is received.

At (S1020), a syntax element is parsed from the bitstream, the syntax element indicates whether an adaptive linear wavelet transform is used, the adaptive linear wavelet transform applies different weight values to different neighboring vertices of a vertex in a wavelet transform of attribute values associated with vertices of the mesh frame.

At (S1030), when the syntax element indicates a use of the adaptive linear wavelet transform, at least a first vertex in the vertices of the mesh frame is reconstructed according to the adaptive linear wavelet transform.

In some examples, the syntax element is a one-bit flag. For example, a value of “1” of the one-bit flag indicates a use of the adaptive linear wavelet transform, and a value of “0” of the one-bit flag indicates no-use of the adaptive linear wavelet transform.

In some examples, when the syntax element indicates no use of the adaptive linear wavelet transform, the first vertex is reconstructed by using a same weight value applied to different neighboring vertices of the first vertex.

In some examples, the attribute values include displacement vectors associated with the vertices in the mesh frame.

According to an aspect, to reconstruct, a first weight value to weight a first detail coefficient associated with a first neighboring vertex of the first vertex is determined based on a first distance between the first neighboring vertex and the first vertex, and a value associated with the first vertex is updated according to the first detail coefficient that is weighted with the first weight value. In some examples, the first weight value is calculated based on a reciprocal of the first distance between the first neighboring vertex and the first vertex. In some examples, the first weight value is calculated based on a counting number of different neighboring vertices of the first vertex.

In some aspects, respective weight values to weight detail coefficients associated with first neighboring vertices of the first vertex are determined based on respective distances between the first neighboring vertices and the first vertex. A weighted sum of the detail coefficients that are respectively weighted by the respective weight values is calculated. The weighted sum is divided by a counting number of the first neighboring vertices to calculate an average. A value associated with the first vertex is updated according to the average, such as shown by Eq. (5) and Eq. (6). For example, the first vertex is of a lower level of detail (LoD) than the first neighboring vertices.

In some examples, at least a first weighting coefficient for an update filter in the wavelet transform of the attribute values and a second weighting coefficient used for a prediction filter in the wavelet transform of the attribute values are extracted from the bitstream. In an example, when the syntax element indicates no use of the adaptive linear wavelet transform, at least the first weighting coefficient and the second weighting coefficient are extracted from the bitstream. In another example, weighting coefficients of the prediction filter and the update filter, such as the first weighting coefficient and the second weighting coefficient, are extracted from the bitstream no matter of the syntax element; however, when the syntax element indicates a use of the adaptive linear wavelet transform, the weighting coefficients, such as the weighting coefficients of the update filter are modified based on the distance(s) and/or valence(s).

Then, the process proceeds to (S1099) and terminates.

The process (1000) can be suitably adapted. Step(s) in the process (1000) can be modified and/or omitted. Additional step(s) can be added. Any suitable order of implementation can be used.

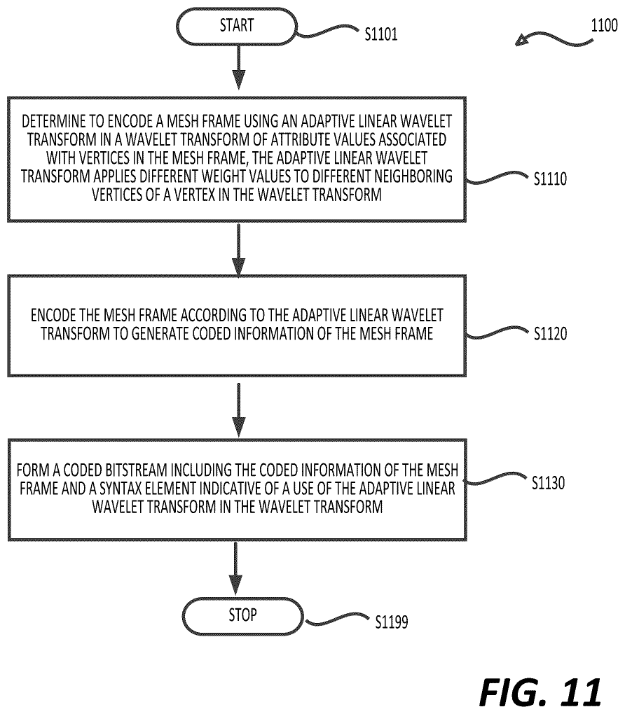

FIG. 11 shows a flow chart outlining a process (1100) according to an aspect of the disclosure. The process (1100) can be used in a video encoder. In various aspects, the process (1100) is executed by processing circuitry, such as the processing circuitry that performs functions of the video encoder (103), the processing circuitry that performs functions of the video encoder (303), and the like. In some aspects, the process (1100) is implemented in software instructions, thus when the processing circuitry executes the software instructions, the processing circuitry performs the process (1100). The process starts at (S1101) and proceeds to (S1110).

At (S1110), to encode a mesh frame using an adaptive linear wavelet transform in a wavelet transform of attribute values associated with vertices in the mesh frame is determined. The adaptive linear wavelet transform applies different weight values to different neighboring vertices of a vertex in the wavelet transform.

At (S1120), the mesh frame is encoded according to the adaptive linear wavelet transform to generate coded information of the mesh frame.

At (S1130), a coded bitstream is formed, the coded bitstream includes the coded information of the mesh frame and a syntax element indicative of a use of the adaptive linear wavelet transform in the wavelet transform.

In some examples, the syntax element is a one-bit flag. For example, a value of “1” of the one-bit flag indicates a use of the adaptive linear wavelet transform, and a value of “0” of the one-bit flag indicates no-use of the adaptive linear wavelet transform.

In some examples, the attribute values include displacement vectors associated with the vertices in the mesh frame.

According to an aspect, to encode, a first weight value to weight a first detail coefficient associated with a first neighboring vertex of a first vertex is determined based on a first distance between the first neighboring vertex and the first vertex, and a value associated with the first vertex is updated according to the first detail coefficient that is weighted with the first weight value. In some examples, the first weight value is calculated based on a reciprocal of the first distance between the first neighboring vertex and the first vertex. In some examples, the first weight value is calculated based on a counting number of different neighboring vertices of the first vertex.

In some examples, respective weight values to weight detail coefficients associated with first neighboring vertices of a first vertex are determined based on respective distances between the first neighboring vertices and the first vertex. A weighted sum of the detail coefficients that are respectively weighted by the respective weight values is calculated. The weighted sum is divided by a counting number of the first neighboring vertices to calculate an average. A value associated with the first vertex is updated according to the average. In an example, the first vertex is of a lower level of detail (LoD) than the first neighboring vertices.

In some examples, the coded bitstream includes at least a first weighting coefficient for an update filter in the wavelet transform of the attribute values and a second weighting coefficient used for a prediction filter in the wavelet transform of the attribute values. In an example, when the syntax element indicates no use of the adaptive linear wavelet transform, the coded bitstream includes at least the first weighting coefficient and the second weighting coefficient. In another example, the coded bitstream includes weighting coefficients of the prediction filter and the update filter, such as the first weighting coefficient and the second weighting coefficient, no matter of the syntax element; however, when the syntax element indicates a use of the adaptive linear wavelet transform, the weighting coefficients, such as the weighting coefficients of the update filter are modified based on the distance(s) and/or valence(s) and then the modified weighting coefficients can be used in the prediction filter and the update filter.

Then, the process proceeds to (S1199) and terminates.

The process (1100) can be suitably adapted. Step(s) in the process (1100) can be modified and/or omitted. Additional step(s) can be added. Any suitable order of implementation can be used.

In an aspect, a method of processing mesh data includes processing a bitstream of the mesh data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In some examples, the bitstream includes coded information of a plurality of vertices in a mesh frame. The format rule specifies that a syntax element is parsed from the bitstream, the syntax element indicates whether an adaptive linear wavelet transform is used, the adaptive linear wavelet transform applies different weight values to different neighboring vertices of a vertex in a wavelet transform of attribute values associated with vertices of the mesh frame. When the syntax element indicates a use of the adaptive linear wavelet transform, at least a first vertex in the vertices of the mesh frame is reconstructed according to the adaptive linear wavelet transform.

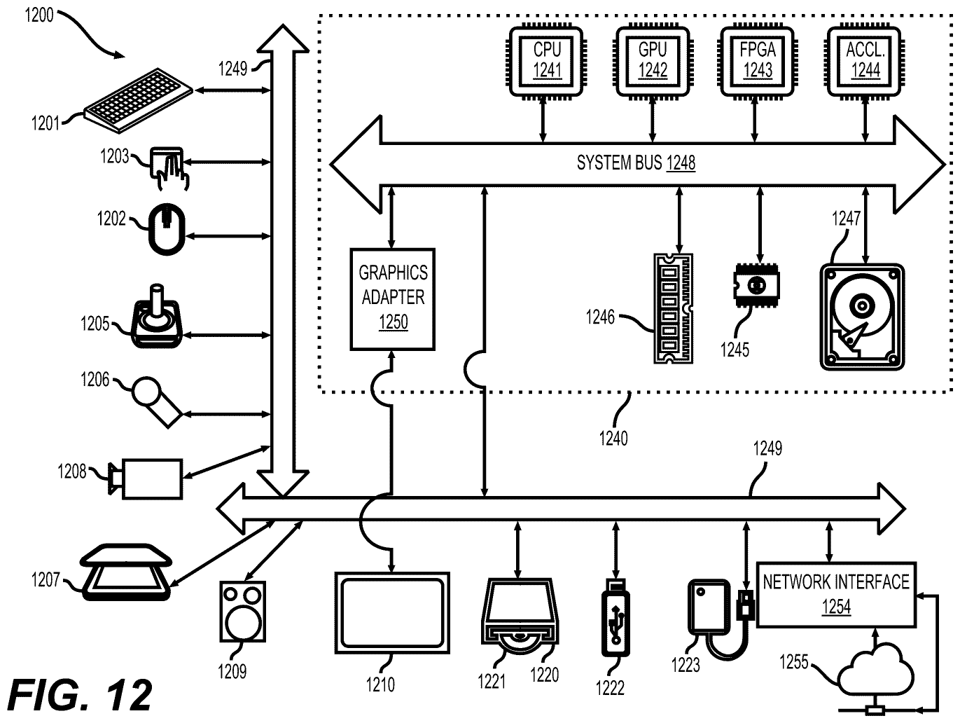

The techniques described above, can be implemented as computer software using computer-readable instructions and physically stored in one or more computer-readable media. For example, FIG. 12 shows a computer system (1200) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 12 for computer system (1200) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1200).

Computer system (1200) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1201), mouse (1202), trackpad (1203), touch screen (1210), data-glove (not shown), joystick (1205), microphone (1206), scanner (1207), camera (1208).

Computer system (1200) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1210), data-glove (not shown), or joystick (1205), but there can also be tactile feedback devices that do not serve as input devices), audio output devices (such as: speakers (1209), headphones (not depicted)), visual output devices (such as screens (1210) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1200) can also include human accessible storage devices and their associated media such as optical media including CD/DVD ROM/RW (1220) with CD/DVD or the like media (1221), thumb-drive (1222), removable hard drive or solid state drive (1223), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1200) can also include an interface (1254) to one or more communication networks (1255). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1249) (such as, for example USB ports of the computer system (1200)); others are commonly integrated into the core of the computer system (1200) by attachment to a system bus as described below (for example Ethernet interface into a PC computer system or cellular network interface into a smartphone computer system). Using any of these networks, computer system (1200) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1240) of the computer system (1200).

The core (1240) can include one or more Central Processing Units (CPU) (1241), Graphics Processing Units (GPU) (1242), specialized programmable processing units in the form of Field Programmable Gate Areas (FPGA) (1243), hardware accelerators for certain tasks (1244), graphics adapters (1250), and so forth. These devices, along with Read-only memory (ROM) (1245), Random-access memory (1246), internal mass storage such as internal non-user accessible hard drives, SSDs, and the like (1247), may be connected through a system bus (1248). In some computer systems, the system bus (1248) can be accessible in the form of one or more physical plugs to enable extensions by additional CPUs, GPU, and the like. The peripheral devices can be attached either directly to the core's system bus (1248), or through a peripheral bus (1249). In an example, the screen (1210) can be connected to the graphics adapter (1250). Architectures for a peripheral bus include PCI, USB, and the like.

CPUs (1241), GPUs (1242), FPGAs (1243), and accelerators (1244) can execute certain instructions that, in combination, can make up the aforementioned computer code. That computer code can be stored in ROM (1245) or RAM (1246). Transitional data can also be stored in RAM (1246), whereas permanent data can be stored for example, in the internal mass storage (1247). Fast storage and retrieve to any of the memory devices can be enabled through the use of cache memory, that can be closely associated with one or more CPU (1241), GPU (1242), mass storage (1247), ROM (1245), RAM (1246), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1200), and specifically the core (1240) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1240) that are of non-transitory nature, such as core-internal mass storage (1247) or ROM (1245). The software implementing various aspects of the present disclosure can be stored in such devices and executed by core (1240). A computer-readable medium can include one or more memory devices or chips, according to particular needs. The software can cause the core (1240) and specifically the processors therein (including CPU, GPU, FPGA, and the like) to execute particular processes or particular parts of particular processes described herein, including defining data structures stored in RAM (1246) and modifying such data structures according to the processes defined by the software. In addition or as an alternative, the computer system can provide functionality as a result of logic hardwired or otherwise embodied in a circuit (for example: accelerator (1244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1). A method of mesh decoding, including: receiving a bitstream that includes coded information of a mesh frame; parsing a syntax element from the bitstream, the syntax element indicating whether an adaptive linear wavelet transform is used, the adaptive linear wavelet transform applying different weight values to different neighboring vertices of a vertex in a wavelet transform of attribute values associated with vertices of the mesh frame; and reconstructing, when the syntax element indicates a use of the adaptive linear wavelet transform, at least a first vertex in the vertices of the mesh frame according to the adaptive linear wavelet transform.

(2). The method of feature (1), in which the syntax element is a one-bit flag.

(3). The method of any of features (1) to (2), further including: reconstructing, when the syntax element indicates no use of the adaptive linear wavelet transform, the first vertex with same weight values applied to different neighboring vertices of the first vertex.

(4). The method of any of features (1) to (3), in which the attribute values include displacement vectors associated with the vertices in the mesh frame.

(5). The method of any of features (1) to (4), in which the reconstructing includes: determining a first weight value to weight a first detail coefficient associated with a first neighboring vertex of the first vertex based on a first distance between the first neighboring vertex and the first vertex; and updating a value associated with the first vertex according to the first detail coefficient that is weighted with the first weight value.

(6). The method of any of features (1) to (5), in which the first weight value is calculated based on a reciprocal of the first distance between the first neighboring vertex and the first vertex.

(7). The method of any of features (1) to (6), in which the first weight value is calculated based on a counting number of different neighboring vertices of the first vertex.

(8). The method of any of features (1) to (7), in which the reconstructing includes: determining respective weight values to weight detail coefficients associated with first neighboring vertices of the first vertex based on respective distances between the first neighboring vertices and the first vertex; calculating a weighted sum of the detail coefficients that are respectively weighted by the respective weight values; dividing the weighted sum by a counting number of the first neighboring vertices to calculate an average; and updating a value associated with the first vertex according to the average.

(9). The method of any of features (1) to (8), in which the first vertex is of a lower level of detail (LoD) than the first neighboring vertices.

(10). The method of any of features (1) to (9), further including: extracting, from the bitstream, at least a first weighting coefficient for an update filter in the wavelet transform of the attribute values and a second weighting coefficient used for a prediction filter in the wavelet transform of the attribute values.

(11). A method of mesh encoding, including: determining to encode a mesh frame using an adaptive linear wavelet transform in a wavelet transform of attribute values associated with vertices in the mesh frame, the adaptive linear wavelet transform applying different weight values to different neighboring vertices of a vertex in the wavelet transform; encoding the mesh frame according to the adaptive linear wavelet transform to generate coded information of the mesh frame; and forming a coded bitstream including the coded information of the mesh frame and a syntax element indicative of a use of the adaptive linear wavelet transform in the wavelet transform.

(12). The method of feature (11), in which the syntax element is a one-bit flag.

(13). The method of any of features (11) to (12), in which the attribute values include: displacement vectors associated with the vertices in the mesh frame.

(14). The method of any of features (11) to (13), in which the encoding includes: determining a first weight value to weight a first detail coefficient associated with a first neighboring vertex of a first vertex based on a first distance between the first neighboring vertex and the first vertex; and updating a value associated with the first vertex according to the first detail coefficient that is weighted with the first weight value.

(15). The method of any of features (11) to (14), in which the first weight value is calculated based on a reciprocal of the first distance between the first neighboring vertex and the first vertex.

(16). The method of any of features (11) to (15), in which the first weight value is calculated based on a counting number of different neighboring vertices of the first vertex.

(17). The method of any of features (11) to (16), in which the encoding includes: determining respective weight values to weight detail coefficients associated with first neighboring vertices of a first vertex based on respective distances between the first neighboring vertices and the first vertex; calculating a weighted sum of the detail coefficients that are respectively weighted by the respective weight values; dividing the weighted sum by a counting number of the first neighboring vertices to calculate an average; and updating a value associated with the first vertex according to the average.

(18). The method of any of features (11) to (17), in which the first vertex is of a lower level of detail (LoD) than the first neighboring vertices.

(19). The method of any of features (11) to (18), further including: including, in the coded bitstream, at least a first weighting coefficient for an update filter in the wavelet transform of the attribute values and a second weighting coefficient used for a prediction filter in the wavelet transform of the attribute values.

(20). A method of processing mesh data, the method including: processing a bitstream of the mesh data according to a format rule, in which: the bitstream includes coded information of a plurality of vertices in a mesh frame; and the format rule specifies that: a syntax element is parsed from the bitstream, the syntax element indicating whether an adaptive linear wavelet transform is used, the adaptive linear wavelet transform applying different weight values to different neighboring vertices of a vertex in a wavelet transform of attribute values associated with vertices of the mesh frame; and when the syntax element indicates a use of the adaptive linear wavelet transform, at least a first vertex in the vertices of the mesh frame is reconstructed according to the adaptive linear wavelet transform.

(21). An apparatus for mesh decoding, including processing circuitry that is configured to perform the method of any of features (1) to (10).

(22). An apparatus for mesh encoding, including processing circuitry that is configured to perform the method of any of features (11) to (19).

(23). A non-transitory computer-readable storage medium storing instructions which when executed by at least one processor cause the at least one processor to perform the method of any of features (1) to (20).

What is claimed is:

1. A method of mesh decoding, comprising:
receiving a bitstream that includes coded information of a mesh frame;
parsing a syntax element from the bitstream, the syntax element indicating whether an adaptive linear wavelet transform is used, the adaptive linear wavelet transform applying different weight values to different neighboring vertices of a vertex in a wavelet transform of attribute values associated with vertices of the mesh frame; and
reconstructing, when the syntax element indicates a use of the adaptive linear wavelet transform, at least a first vertex in the vertices of the mesh frame according to the adaptive linear wavelet transform.

2. The method of claim 1, wherein the syntax element is a one-bit flag.

3. The method of claim 1, further comprising:
reconstructing, when the syntax element indicates no use of the adaptive linear wavelet transform, the first vertex with same weight values applied to different neighboring vertices of the first vertex.

4. The method of claim 1, wherein the attribute values comprise displacement vectors associated with the vertices in the mesh frame.

5. The method of claim 1, wherein the reconstructing comprises:
determining a first weight value to weight a first detail coefficient associated with a first neighboring vertex of the first vertex based on a first distance between the first neighboring vertex and the first vertex; and
updating a value associated with the first vertex according to the first detail coefficient that is weighted with the first weight value.

6. The method of claim 5, wherein the first weight value is calculated based on a reciprocal of the first distance between the first neighboring vertex and the first vertex.

7. The method of claim 5, wherein the first weight value is calculated based on a counting number of different neighboring vertices of the first vertex.

8. The method of claim 1, wherein the reconstructing comprises:
determining respective weight values to weight detail coefficients associated with first neighboring vertices of the first vertex based on respective distances between the first neighboring vertices and the first vertex;
calculating a weighted sum of the detail coefficients that are respectively weighted by the respective weight values;
dividing the weighted sum by a counting number of the first neighboring vertices to calculate an average; and
updating a value associated with the first vertex according to the average.

9. The method of claim 8, wherein the first vertex is of a lower level of detail (LoD) than the first neighboring vertices.

10. The method of claim 1, further comprising:
extracting, from the bitstream, at least a first weighting coefficient for an update filter in the wavelet transform of the attribute values and a second weighting coefficient used for a prediction filter in the wavelet transform of the attribute values.

11. A method of mesh encoding, comprising:
determining to encode a mesh frame using an adaptive linear wavelet transform in a wavelet transform of attribute values associated with vertices in the mesh frame, the adaptive linear wavelet transform applying different weight values to different neighboring vertices of a vertex in the wavelet transform;
encoding the mesh frame according to the adaptive linear wavelet transform to generate coded information of the mesh frame; and
forming a coded bitstream including the coded information of the mesh frame and a syntax element indicative of a use of the adaptive linear wavelet transform in the wavelet transform.

12. The method of claim 11, wherein the syntax element is a one-bit flag.

13. The method of claim 11, wherein the attribute values comprise displacement vectors associated with the vertices in the mesh frame.

14. The method of claim 11, wherein the encoding comprises:
determining a first weight value to weight a first detail coefficient associated with a first neighboring vertex of a first vertex based on a first distance between the first neighboring vertex and the first vertex; and
updating a value associated with the first vertex according to the first detail coefficient that is weighted with the first weight value.

15. The method of claim 14, wherein the first weight value is calculated based on a reciprocal of the first distance between the first neighboring vertex and the first vertex.

16. The method of claim 14, wherein the first weight value is calculated based on a counting number of different neighboring vertices of the first vertex.

17. The method of claim 11, wherein the encoding comprises:
determining respective weight values to weight detail coefficients associated with first neighboring vertices of a first vertex based on respective distances between the first neighboring vertices and the first vertex;
calculating a weighted sum of the detail coefficients that are respectively weighted by the respective weight values;
dividing the weighted sum by a counting number of the first neighboring vertices to calculate an average; and
updating a value associated with the first vertex according to the average.

18. The method of claim 17, wherein the first vertex is of a lower level of detail (LoD) than the first neighboring vertices.

19. The method of claim 11, further comprising:
including, in the coded bitstream, at least a first weighting coefficient for an update filter in the wavelet transform of the attribute values and a second weighting coefficient used for a prediction filter in the wavelet transform of the attribute values.

20. A method of processing mesh data, the method comprising:
processing a bitstream of the mesh data according to a format rule, wherein:
the bitstream includes coded information of a plurality of vertices in a mesh frame; and
the format rule specifies that:
a syntax element is parsed from the bitstream, the syntax element indicating whether an adaptive linear wavelet transform is used, the adaptive linear wavelet transform applying different weight values to different neighboring vertices of a vertex in a wavelet transform of attribute values associated with vertices of the mesh frame; and
when the syntax element indicates a use of the adaptive linear wavelet transform, at least a first vertex in the vertices of the mesh frame is reconstructed according to the adaptive linear wavelet transform.
